(19) United States
(12) Patent Application Publication
(10) Pub. No.: US 2003/0005219 A1
(43) Pub. Date: Jan. 2, 2003

(54) Partitioning cache metadata state

(76) Inventors: Robert J. Royer JR., Portland, OR (US); Knut S. Grimsrud, Forest Grove, OR (US); Richard L. Coulson, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/895,578

(22) Filed: Jun. 29, 2001

(51) Int. Cl. G06F 12/00

(52) U.S. Cl. 711/113; 711/203

(57) ABSTRACT

An apparatus and method to reduce the initialization time of a system is disclosed. In one embodiment, the invention stores metadata for data in a cache memory in a partitioned section of a non-volatile storage media. This allows multiple metadata entries to be read in one operation, thereby improving system performance.

### FIELD

The invention relates to operating systems, and more particularly, to cache memory devices in operating systems.

### GENERAL DESCRIPTION

The use of a cache in a computer reduces memory access time and increases the overall speed of a device. Typically, a cache is an area of memory which serves as a temporary storage area for a device and has a shorter access time than the device it is caching. Data frequently accessed by the processor remain in the cache after an initial access and subsequent accesses to the same data may be made to the cache.

Two types of caching are commonly used, memory caching and disk caching. A memory cache, sometimes known as cache store, is typically a high-speed memory device such as a static random access memory (SRAM). Memory caching is effective because most programs access the same data or instructions repeatedly.

Disk caching works under the same principle as memory caching but uses a conventional memory device such as a dynamic random access memory (DRAM). The most recently accessed data from the disk is stored in the disk cache. When a program needs to access the data from the disk, the disk cache is first checked to see if the data is in the disk cache. Disk caching can significantly improve the performance of applications because accessing a byte of data in RAM can be thousands of times faster than accessing a byte on a disk.

Both the SRAM and DRAM are volatile. Therefore, in systems using a volatile memory as the cache memory, data stored in the cache memory would be lost when the power is shut off to the system. Accordingly, some existing devices may have a battery backup to ‘emulate’ the behavior of a non-volatile cache by not letting the device go un-powered. However, using an emulated cache increases the cost and reduces the reliability of the device, thereby making it unattractive to users.

In other devices, data is moved from the cache to a non-volatile storage device to preserve the cache data through a system shutdown or power failure. However, in order to use the data that has been stored on the non-volatile storage device, the state of the cache or meta-data need to be preserved. If the state is not preserved the system still needs to re-initialize the cache because the state of data currently in the cache is unknown.

Although the initialization time is not long in smaller caches (tens of megabytes), the initialization time for a cache in the Gigabyte range can possibly last longer than a typical personal computer (PC) use session.

### BRIEF DESCRIPTION OF THE DRAWINGS

The invention will be described in detail with reference to the following drawings in which like reference numerals refer to like elements wherein:

FIG. 1 is an exemplary system in accordance to one embodiment of the invention;

FIG. 2 is an exemplary memory layout in accordance to one embodiment of the invention; and

FIG. 3 shows an exemplary storage method in accordance with one embodiment of the invention.

### DETAILED DESCRIPTION

In the following description, specific details are given to provide a thorough understanding of the invention. For example, some circuits are shown in block diagram in order not to obscure the present invention in unnecessary detail. However, it will be understood by those skilled in the art that the present invention may be practiced without such specific details.

As disclosed herein, a “cache” refers to a temporary storage area and can be either a memory cache or a disk cache. The term “system boot” refers to initialization of a computer both when the power is first turned on, known as cold booting, and when a computer is restarted, known as warm booting. The term “computer readable medium” includes, but is not limited to portable or fixed storage devices, optical storage devices, and any other memory devices capable of storing computer instructions and/or data. The term “computer instructions” are software or firmware including data, codes, and programs that can be read and/or executed to perform certain tasks.

Generally, a non-volatile storage media is used as a non-volatile data cache. In one embodiment of the invention, the cache state metadata is stored in a partitioned section of the non-volatile storage media. By storing this metadata in the non-volatile storage media, the cache state can be preserved through a power failure or normal system shutdown.

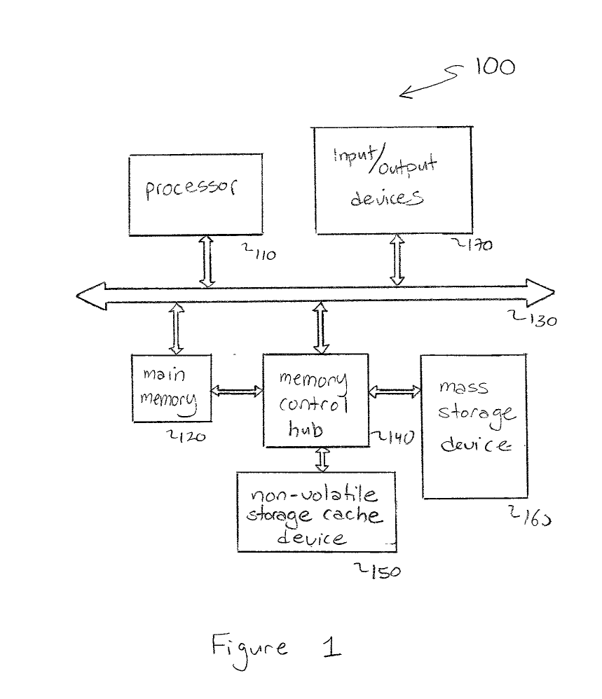

An exemplary embodiment of a system 100 implementing the principles of the invention is shown in FIG. 1. The system 100 includes a processor 110 coupled to a main memory 120 by a bus 130. The main memory 110 may comprise of a random-access-memory (RAM) and is coupled to a memory control hub 140. The memory control hub 140 is also coupled to the bus 130, to a nonvolatile storage cache device 150 and to a mass storage device 160. The mass storage device 160 may be a hard disk drive, a floppy disk drive, a compact disc (CD) drive, a Flash memory (NAND and NOR types, including multiple bits per cell), a ferroelectric RAM (FRAM), or a polymer FRAM (PFRAM) or any other existing or future memory device for mass storage of information. The memory control hub 140 controls the operations of the main memory 120, the non-volatile storage cache device 150 and the mass storage device 160. Finally, a number of input/output devices 170 such as a keyboard, mouse and/or display may be coupled to the bus 130.

Although the system 100 is shown as a system with a single processor, the invention may be implemented with multiple processors, in which additional processors would be coupled to the bus 130. In such case, each additional processor would share the non-volatile storage cache device 150 and main memory 120 for writing data and/or instructions to and reading data and/or instructions from the same. Also, the non-volatile storage cache device 150 is shown external to the mass storage device 160. However, the non-volatile storage cache device 150 can be internally implemented into any non-volatile media in a system. For example, in one embodiment, the non-volatile storage cache device 150 can be a portion of the mass storage device 160. The invention will next be described below.

Because retrieving data from the mass storage device 160 can be slow, caching can be achieved by storing data recently accessed from the mass storage device 160 in a non-volatile storage media such as the non-volatile storage cache device 150. Next time the data is needed, it may be available in the non-volatile storage cache device 150, thereby avoiding a time-consuming search and fetch in the mass storage device 160. The non-volatile storage cache device 150 can also be used for writing. In particular, data can be written to the non-volatile storage cache device 150 at high speed and then stored until the data is written to the mass storage device, for example, during idle machine cycles or idle cycles in a mass storage subsystem.

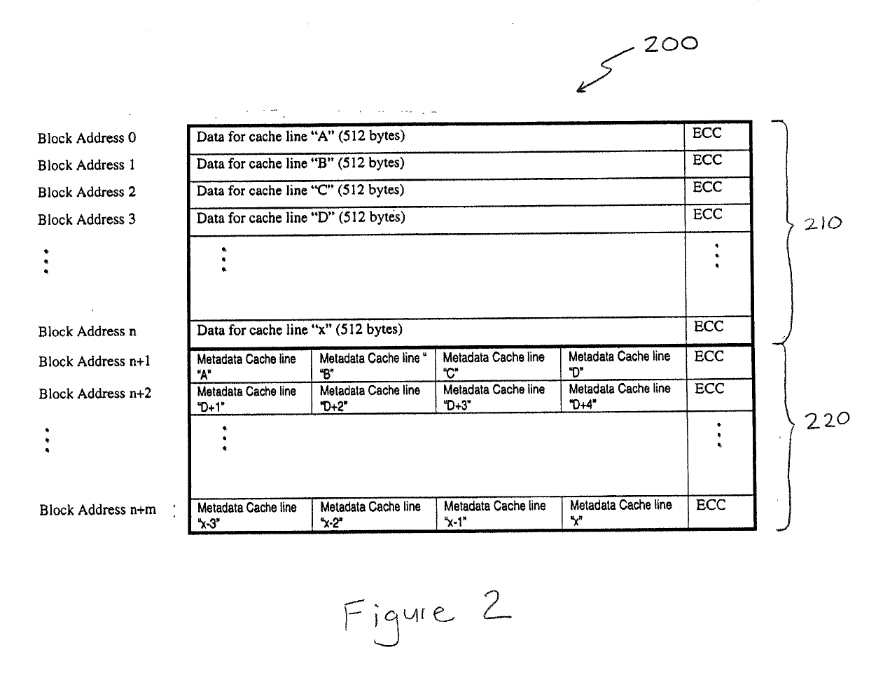

FIG. 2 shows an exemplary layout of a non-volatile storage media 200 including a first section 210 and a second section 220. In the first section 210, the data with corresponding error correction code (ECC) can respectively be stored in cache lines “A,” “B,” “C,” “D”. . . “x” with corresponding block addresses 0, 1, 2, 3 . . . n. In the second section 220, metadata for cache lines “A,” “B,” “C,” “D” “x” with corresponding ECC can respectively be stored in block addresses “n+1,” “n+2”. . . “n+m.” Here, the ECC is for recovering the metadata stored in a corresponding block address. Also, although the non-volatile storage media 200 is showno to have a memory line of 512 bytes, the size of the cache line may vary depending upon the needs of the system 100.

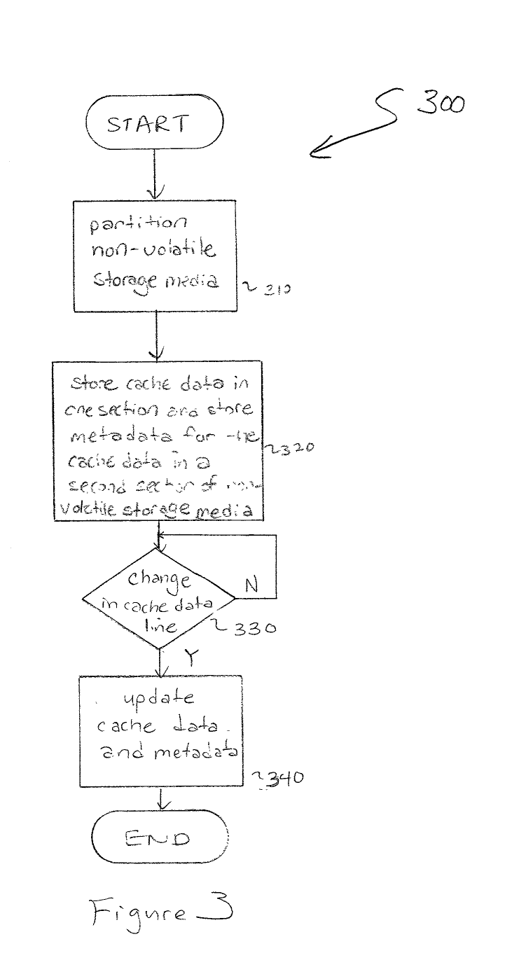

FIG. 3 shows an exemplary embodiment of data storage and access method 300 in accordance with the invention. Referring to FIG. 3, a non-volatile storage media is partitioned (block 310). In one embodiment, the partitioning is logical. Using the non-volatile storage media as a cache memory device, the memory control hub 140 in FIG. 1 causes cache data to be stored in a first partitioned section, for example, the first section 210 of FIG. 2, and causes metadata for the cache data to be stored in a second partitioned section, for example, the second section 220 (block 320). In one embodiment, as shown in FIG. 2, the metadata is partitioned into packed metadata blocks. As a result, each line of the second section may contain information about several cache lines.

The cache data and metadata are then updated when a line of cache data in the first section is changed (blocks 330 and 340). A line of cache data may change as new data is stored and/or existing lines of stored data is replaced or de-allocated to make room for new lines of data. Here, any caching algorithm can be used to update the data and metadata. In one embodiment, the cache data and metadata is updated atomically with respect to a system power fail. The use of an atomic update insures that there will be no race-condition in maintaining both the cache data and the metadata due to a power fail, thereby insuring the maintenance of data integrity.

By storing both the metadata and the data on a non-volatile media, the state of the cache and its respective data can be accessed upon a system boot, resulting in a significant reduction of the initialization time for a cache. This is particularly useful as the size of the cache grows, for example, to a Gigabyte range.

Accordingly, when the state of the cache needs to be known such as when a system boot is detected, the partitioned section of a non-volatile storage media may be accessed to read metadata entries to determine the state of the cache. If the metadata is stored as packed metadata blocks, one line or block of the partitioned section of a non-volatile storage media would contain metadata information of several cache lines. Therefore, multiple metadata entries can be read in one operation. In another embodiment, the partitioned section of a non-volatile storage media storing the metadata can be queried as data requests are issued from a host such as a processor.

Normally, users would benefit by a quicker initiation of system operations. This could occur in at least three areas. Initially, when a computer is turned on or the user runs a new program, operations should begin as quickly as possible. Second, when a program error or crash occurs, the computer should be restarted as soon as possible. Similarly, when a variety of issues come up during the course of computer operation, some users may want to simply restart the computer to avoid dealing with and identifying the source of the problem.

Typical cache devices are volatile and should be rebuilt on a next system boot. However, the storage and access method in accordance with the invention eliminates the need and time necessary to rebuild the cache on a system boot. By storing the metadata on a partitioned section of the non-volatile storage media, the state of the cache can correctly be determined on a next system boot. This enables the full benefit of having the cache pre-warmed or fully occupied with data, because the user data and program code is already stored in the faster cache from previous user sessions. As a result, the system performance is improved on the next system boot/power on.

While the metadata can be appended onto each cache line or stored in a volatile system memory, partitioning the meta-data into a separate array allows for several cost and performance advantages. One such advantage is that the partitioning allows the metadata to be stored into packed metadata blocks for more efficient access to metadata, as information about several cache lines in the same operation can be obtained as apposed to a unique request per cache line. Another advantage is that the standard array layout of the metadata can simplify both the layout and device logic design, reducing the overall cost of a memory device. Furthermore, the invention can simply and easily be implemented by using a mass storage device that is logically partitioned for use as a cache device through software/firmware programming. This also lowers cost and improves development time by reducing the number of unique memory device designs needed.

Finally, although the invention has been discussed with reference to a cache memory device, the teachings of the invention can be applied to other memory devices storing data and state data. Accordingly, the foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

[image]

What is claimed is:

1. A method comprising:
partitioning a non-volatile storage media;
storing data in a first partitioned section of the non-volatile storage media; and
storing, in a second partitioned section of the non-volatile storage media, metadata corresponding to the data stored in the first partitioned section of the nonvolatile storage media.

2. The method of claim 1, wherein storing the metadata as packed metadata block.

3. The method of claim 1, wherein the partitioning is logical.

4. The method of claim 1, wherein storing cache data in the first partitioned section.

5. The method of claim 4, further comprising:
updating the data and metadata atomically when a line of cache data in the first partitioned section is changed.

6. The method of claim 1, further comprising:
allocating a portion of a mass storage device as the non-volatile storage media.

7. A non-volatile memory comprising:
a first section to store data; and
a second section partitioned from the first section, the second section to store metadata for the data stored in the first section.

8. The memory of claim 7, wherein the second section is to store the metadata as packed metadata blocks.

9. The memory of claim 7, wherein the partitioning of the first section and the second section is logical.

10. The memory of claim 7, wherein the non-volatile memory is a portion of a massive storage device.

11. The memory of claim 10, wherein the mass storage device is one of a disk drive, a Flash memory, a ferroelectric random access memory, or a polymer ferroelectric random access memory.

12. The memory of claim 7, wherein the non-volatile memory is a cache memory.

13. A system comprising:
a non-volatile storage media having a first section and a second section partitioned from the first section; and
a memory control hub to cause the first section to store data and the second section to store metadata for the data stored in the first section.

14. The system of claim 13, wherein second section is to store the metadata as packed metadata blocks.

15. The system of claim 13, wherein the partition is logical.

16. The system of claim 15, further comprising a massive storage device and wherein a portion of the massive storage device is the non-volatile storage media.

17. The system of claim 13, wherein the non-volatile storage media is a cache memory.

18. A method comprising:
partitioning a non-volatile storage media;
storing cache data in a first partitioned section of the non-volatile storage media;
storing metadata corresponding to the cache data in a second partitioned section of the non-volatile storage media; and
accessing the second partitioned section to determine the state of the cache data in a system boot.

19. The method of claim 18, wherein storing the metadata in the second partitioned section as packed metadata blocks.

20. The method of claim 18, wherein the partition is logical.

21. The method of claim 18, further comprising:
updating the cache data and metadata atomically when a line of cache data in the first partitioned section is changed.

22. A program loaded in a computer readable medium comprising:
a first group of computer instructions to logically partition a non-volatile storage media;
a second group of computer instructions to store data in a first partitioned section of the non-volatile storage media; and
a third group of computer instructions to store metadata for the data in a second partitioned section of the non-volatile storage media.

23. The program of claim 22, wherein the second group of computer instructions include computer instructions to store the metadata as packed metadata blocks.

24. The program of claim 22, wherein the second group of computer instructions include computer instructions to store cache data as the data in the first partitioned section.

25. The program of claim 24, further comprising:
computer instructions to update the data and metadata atomically when a line of cache data in the first partitioned section is changed.

26. The program of claim 24, further comprising:
computer instructions to access a line of the second partitioned section to read metadata for the cache data in the first partitioned section.

27. A program loaded in a computer readable medium comprising:
a first group of computer instructions to logically partition a non-volatile storage media;
a second group of computer instructions to store cache data in a first partitioned section of a non-volatile storage media;
a third group of computer instructions to store, in a second partitioned section of the non-volatile storage media, metadata corresponding to the cache data stored in the first partitioned section; and
a fourth group of instructions to access the second partitioned section to determine the state of the cache data.

28. The program of claim 27, wherein the third group of computer instructions includes computer instructions to store the metadata as packed metadata blocks.

29. The program of claim 27, further comprising:
computer instructions to update the cache data and metadata atomically when a line of cache data in the first partitioned section is changed.

30. The program of claim 27, further comprising:
computer instructions to allocate a portion of a mass storage device as the non-volatile storage media.

31. A system boot comprising:
accessing a first partitioned section of a non-volatile cache memory to read metadata for cache data stored in a second partitioned section of the non-volatile cache memory; and
determining the state of the cache data based upon the read metadata to initialize the non-volatile cache memory for the system boot.

32. The system boot of claim 31, wherein the metadata is stored in the first partitioned section as packed metadata blocks.

33. The system boot of claim 31, wherein the non-volatile cache memory is logically partitioned into the first and second partitioned sections.

34. The system boot of claim 31, further comprising: allocating a portion of a mass storage device as the non-volatile cache memory.

35. The system boot of claim 34, wherein the mass storage device is one of a disk drive, a Flash memory, a ferroelectric random access memory, or a polymer ferroelectric random access memory.
